(19) United States
(12) Patent Application Publication
(10) Pub. No.: US 2024/0234017 A9
(43) Pub. Date: Jul. 11, 2024

(54) INDUCTOR COMPONENT

(71) Applicant: Murata Manufacturing Co., Ltd., Kyoto-fu (JP)

(72) Inventor: Shingo SAKAGUCHI, Nagaokakyo-shi (JP)

(73) Assignee: Murata Manufacturing Co., Ltd., Kyoto-fu (JP)

(21) Appl. No.: 18/447,004

(22) Filed: Aug. 9, 2023

(30) Foreign Application Priority Data
Oct. 24, 2022 (JP) 2022-169868

(51) Int. Cl. H01F 27/29; H01F 27/28

(52) U.S. Cl. CPC H01F 27/292; H01F 27/2804; H01F 2027/2809

(57) ABSTRACT

An inductor component includes an element body and inductor wiring. The element body has first and second electrodes connected to first and second ends of the inductor wiring, respectively. One outer surface of the element body is a first main surface, one surface perpendicular to the first main surface is a first end surface, and one surface perpendicular to the first main and end surfaces is a bottom surface. The first electrode includes a first bottom surface electrode portion and a first end surface electrode portion. A size of the first bottom surface electrode portion in a direction perpendicular to the bottom surface is a thickness, and a portion of the first bottom surface electrode portion farthest from the first end surface is a leading end. The thickness of at least part of the first bottom surface electrode portion including the leading end decreases toward the leading end.

### CROSS-REFERENCE TO RELATED APPLICATION

This application claims benefit of priority to Japanese Patent Application No. 2022-169868, filed Oct. 24, 2022, the entire content of which is incorporated herein by reference.

### BACKGROUND

### Technical Field

The present disclosure relates to an inductor component.

### Background Art

The inductor component disclosed in Japanese Unexamined Patent Application Publication No. 2017-73536 includes a rectangular parallelepiped element body having six outer surfaces. One of the six outer surfaces of the element body is a bottom surface that faces a substrate when the inductor component is mounted on the substrate or the like. The element body has, as the remaining five outer surfaces, a first main surface perpendicular to the bottom surface, a second main surface parallel to the first main surface, a first end surface perpendicular to the mounting surface and connecting the first main surface and the second main surface, a second end surface parallel to the first end surface, and a top surface parallel to the bottom surface. The element body has a first electrode and a second electrode. The first electrode is exposed to the outside of the element body in a region straddling the first end surface and the bottom surface. The second electrode is exposed to the outside of the element body in a region straddling the second end surface and the bottom surface.

The inductor component includes inductor wiring. The inductor wiring is wound inside the element body. A first end of the inductor wiring is connected to the first electrode. Further, a second end of the inductor wiring is connected to the second electrode.

### SUMMARY

In the inductor component described in Japanese Unexamined Patent Application Publication No. 2017-73536, by increasing a winding diameter of the inductor wiring, an increase of an inductance value and the like may be expected. On the other hand, a space in an element body in which the inductor wiring can be wound is limited. Therefore, it is desired to design each electrode so that as large a space as possible can be ensured for winding the inductor wiring.

Accordingly, the present disclosure is an inductor component, including a rectangular parallelepiped element body having six outer surfaces and inductor wiring extending inside the element body. The element body has a first electrode connected to a first end of the inductor wiring and a second electrode connected to a second end of the inductor wiring. When, among the six outer surfaces of the element body, one specific surface is defined as a main surface, one surface perpendicular to the main surface is defined as an end surface, and one surface perpendicular to the main surface and the end surface is defined as a bottom surface, the first electrode includes a bottom surface electrode portion exposed to the outside of the element body in a region of the bottom surface including a boundary portion with the end surface, and an end surface electrode portion exposed to the outside of the element body in a region of the end surface including a boundary portion with the bottom surface. When a size of the bottom surface electrode portion in a direction perpendicular to the bottom surface is defined as a thickness of the bottom surface electrode portion, and a portion of the bottom surface electrode portion farthest from the end surface is defined as a leading end, the thickness of at least part of the bottom surface electrode portion including the leading end decreases toward the leading end.

With the use of the configuration described above, a region in which inductor wiring can be disposed is increased by an amount corresponding to a decrease in a thickness of a bottom surface electrode portion at a position far from the end surface. Therefore, a winding diameter of inductor wiring may be designed to be larger. By designing a winding diameter of inductor wiring to be larger, an increase in an inductance value may be expected.

Further, the present disclosure is an inductor component, including a rectangular parallelepiped element body having six outer surfaces and inductor wiring extending inside the element body. The element body has a first electrode connected to a first end of the inductor wiring and a second electrode connected to a second end of the inductor wiring. When, among the six outer surfaces of the element body, one specific surface is defined as a main surface, one surface perpendicular to the main surface is defined as an end surface, and one surface perpendicular to the main surface and the end surface is defined as a bottom surface, the first electrode includes a bottom surface electrode portion exposed to the outside of the element body in a region of the bottom surface including a boundary portion with the end surface, and an end surface electrode portion exposed to the outside of the element body in a region of the end surface including a boundary portion with the bottom surface. When a size of the end surface electrode portion in a direction perpendicular to the end surface is defined as a thickness of the end surface electrode portion, and a portion of the end surface electrode portion farthest from the bottom surface is defined as a leading end, the thickness of at least part of the end surface electrode portion including the leading end decreases toward the leading end.

With the use of the configuration described above, a region in which inductor wiring can be disposed is increased by an amount corresponding to a decrease in a thickness of an end surface electrode portion at a position far from the bottom surface. Therefore, a winding diameter of inductor wiring may be designed to be larger. By designing a winding diameter of inductor wiring to be larger, an increase in an inductance value may be expected. A winding diameter of inductor wiring may be increased.

### BRIEF DESCRIPTION OF THE DRAWINGS

FIG. 1 is a perspective view of an inductor component according to a first embodiment;

FIG. 2 is an exploded perspective view of the inductor component according to the first embodiment;

FIG. 3 schematically illustrates the inductor component according to the first embodiment in a see-through manner;

FIG. 4 schematically illustrates an inductor component according to a second embodiment in a see-through manner;

FIG. 5 is a modification of the inductor component; and

FIG. 6 is a modification of the inductor component.

### DETAILED DESCRIPTION

### First Embodiment

Hereinafter, a first embodiment of an inductor component will be described. Note that, in the drawings, components may be illustrated by being enlarged to facilitate understanding. Dimensional ratios of components may be different from actual ones or from those in other figures.

Overall Configuration of Inductor Component

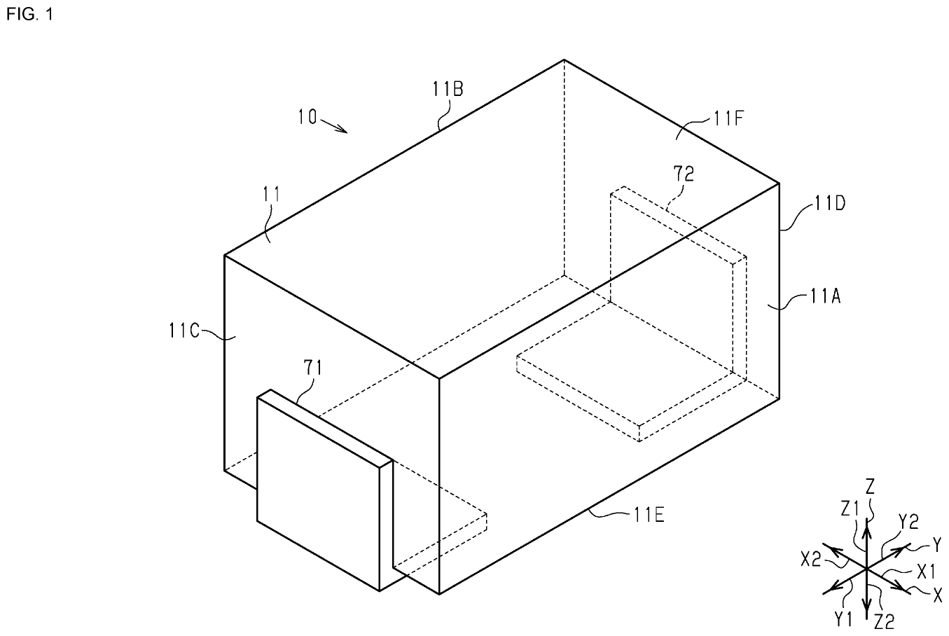

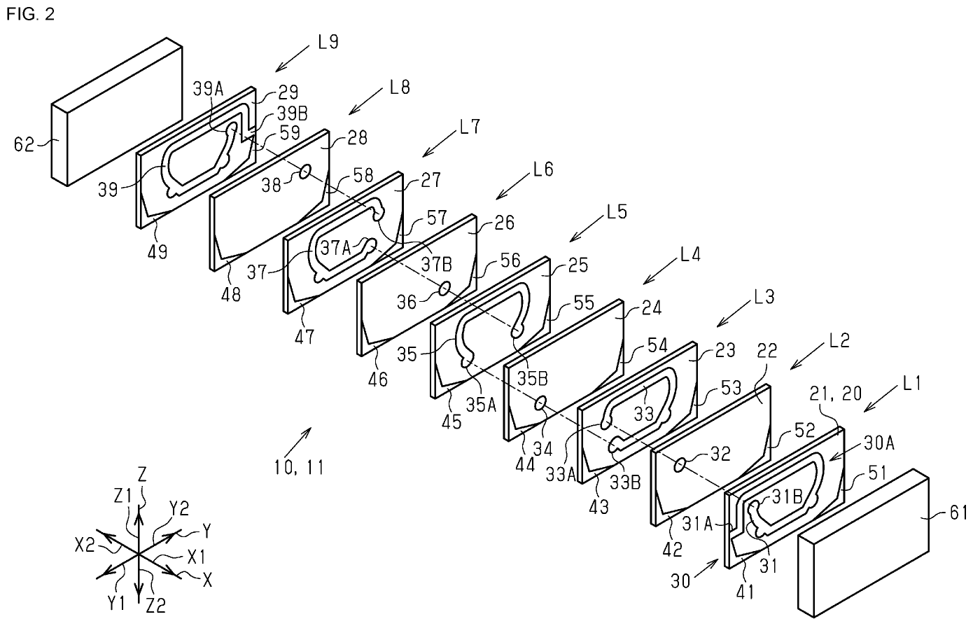

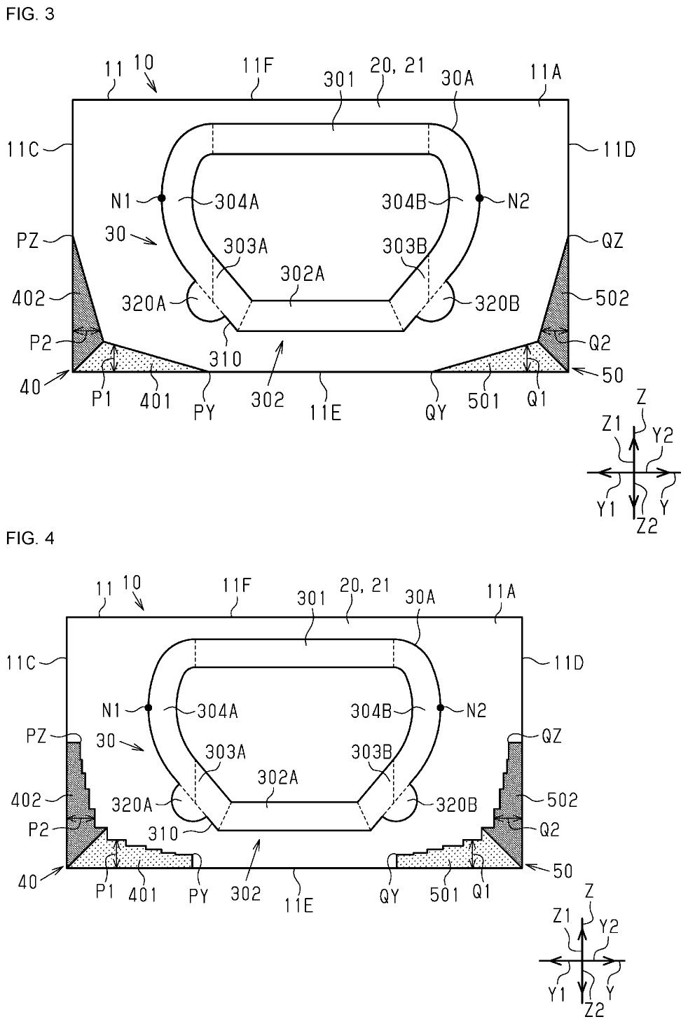

An inductor component 10 includes a rectangular parallelepiped element body 11 as illustrated in FIG. 1. The inductor component 10 includes inductor wiring 30 extending inside the element body 11 as illustrated in FIG. 2 and FIG. 3. The element body 11 has a first electrode 40 connected to a first end of the inductor wiring 30 and a second electrode 50 connected to a second end of the inductor wiring 30.

The inductor component 10, as a whole, has a structure in which multiple plate-shaped layers are stacked as illustrated in FIG. 2. Each layer has a rectangular shape in plan view. Being a rectangular parallelepiped, the element body 11 has six outer surfaces. Among the six outer surfaces, one specific surface parallel to a main surface of each layer is defined as a first main surface 11A as illustrated in FIG. 1. A surface parallel to the first main surface 11A is referred to as a second main surface 11B. Further, one specific surface perpendicular to the first main surface 11A is defined as a first end surface 11C. A surface parallel to the first end surface 11C is referred to as a second end surface 11D. Furthermore, one specific surface perpendicular to the first main surface 11A and the first end surface 11C is defined as a bottom surface 11E. A surface parallel to the bottom surface 11E is referred to as a top surface 11F.

Note that, in the following description, an axis along a direction in which multiple layers are stacked, that is, an axis perpendicular to the first main surface 11A is defined as a first axis X. An axis perpendicular to the first end surface 11C is defined as a second axis Y. Further, an axis perpendicular to the bottom surface 11E is defined as a third axis Z. A direction toward which the first main surface 11A faces, in directions along the first axis X, is defined as a first positive direction X1, and a direction opposite to the first positive direction X1 is defined as a first negative direction X2. Further, a direction toward which the first end surface 11C faces, in directions along the second axis Y, is defined as a second positive direction Y1, and a direction opposite to the second positive direction Y1 is defined as a second negative direction Y2. Furthermore, a direction toward which the top surface 11F faces, in directions along the third axis Z, is defined as a third positive direction Z1, and a direction opposite to the third positive direction Z1 is defined as a third negative direction Z2.

The inductor component 10 includes a first layer L1 to a ninth layer L9 as illustrated in FIG. 2. The first layer L1 to the ninth layer L9 are arranged in this order in the first negative direction X2. Thicknesses of the first layer L1 to the ninth layer L9, that is, the sizes thereof in a direction along the first axis X, are substantially the same. The first layer L1 is composed of a first electrode portion 41, a second electrode portion 51, a first wiring portion 31, and a first insulation portion 21.

The first electrode portion 41 is made of a conductive material such as silver. The first electrode portion 41, as a whole, has an L-shape when the first layer L1 is viewed toward the first negative direction X2. The first electrode portion 41 is positioned on the second positive direction Y1 side and the third negative direction Z2 side relative to a center of the first layer L1, when the first layer L1 is viewed toward the first negative direction X2. More specifically, the first electrode portion 41 is positioned at a portion including a corner of the first layer L1 on the second positive direction Y1 side and the third negative direction Z2 side, when the first layer L1 is viewed toward the first negative direction X2.

A maximum size of the first electrode portion 41 in a direction along the third axis Z is one half or more, specifically, approximately one half of the size of the first layer L1 in the direction along the third axis Z. That is, an end of the first electrode portion 41 on the third positive direction Z1 side is positioned substantially at the center of the first layer L1 in the direction along the third axis Z, or on the third positive direction Z1 side relative to the center. A maximum size of the first electrode portion 41 in a direction along the second axis Y is smaller than half of the size of the first layer L1 in the direction along the second axis Y. That is, an end of the first electrode portion 41 on the second negative direction Y2 side is positioned on the second positive direction Y1 side relative to the center of the first layer L1 in the direction along the second axis Y.

The second electrode portion 51 is made of a conductive material such as silver. The second electrode portion 51, as a whole, has an L-shape when the first layer L1 is viewed toward the first negative direction X2. The second electrode portion 51 is positioned on the second negative direction Y2 side and the third negative direction Z2 side relative to the center of the first layer L1, when the first layer L1 is viewed toward the first negative direction X2. More specifically, the second electrode portion 51 is positioned at a portion including a corner of the first layer L1 on the second negative direction Y2 side and the third negative direction Z2 side, when the first layer L1 is viewed toward the first negative direction X2.

The second electrode portion 51 has a shape symmetrical to the first electrode portion 41 in the direction along the second axis Y. That is, an end of the second electrode portion 51 on the third positive direction Z1 side is positioned substantially at the center of the first layer L1 in the direction along the third axis Z, or on the third positive direction Z1 side relative to the center. Further, an end of the second electrode portion 51 on the second positive direction Y1 side is positioned on the second negative direction Y2 side relative to the center of the first layer L1 in the direction along the second axis Y.

The first wiring portion 31 is made of a conductive material such as silver. The first wiring portion 31, as a whole, spirally extends substantially around the center of the first layer L1, when the first layer L1 is viewed toward the first negative direction X2. A first end portion 31A of the first wiring portion 31 is a portion deviated from a circulation path formed by wiring portions of the first layer L1 to the ninth layer L9 overlapping with each other, when viewed toward the first negative direction X2. The first end portion 31A is connected to an end portion of the first electrode portion 41 on the third positive direction Z1 side in the direction along the third axis Z. That is, the first end portion 31A is a first end of the inductor wiring 30. A position of a second end portion 31B of the first wiring portion 31 in the direction along the third axis Z is on the third positive direction Z1 side relative to the center of the first layer L1. A position of the second end portion 31B of the first wiring portion 31 in the direction along the second axis Y is on the second positive direction Y1 side relative to the center of the first layer L1. The first wiring portion 31 extends clockwise from the first end portion 31A to the second end portion 31B, when the first wiring portion 31 is viewed toward the first negative direction X2. Note that a detailed configuration of the inductor wiring 30 including the first wiring portion 31 will be described later. The second end portion 31B of the first wiring portion 31 functions as a land to connect to a via 32 described later. The second end portion 31B has a substantially circular shape when the first layer L1 is viewed toward the first negative direction X2.

A portion of the first layer L1 excluding the first electrode portion 41, the second electrode portion 51, and the first wiring portion 31 is the first insulation portion 21. The first insulation portion 21 is made of a non-magnetic insulator such as glass, resin, or alumina.

The second layer L2 is disposed on a main surface of the first layer L1 facing the first negative direction X2 as illustrated in FIG. 2. The second layer L2 has the same rectangular shape as that of the first layer L1 when the second layer L2 is viewed toward the first negative direction X2. The second layer L2 is composed of a third electrode portion 42, a fourth electrode portion 52, a via 32, and a second insulation portion 22.

The third electrode portion 42 is made of the same material as that of the first electrode portion 41. The third electrode portion 42 has an L-shape with the same size as that of the first electrode portion 41, and is positioned at the same position as that of the first electrode portion 41, when the second layer L2 is viewed toward the first negative direction X2. Therefore, the third electrode portion 42 is disposed on a surface of the first electrode portion 41 facing the first negative direction X2.

The fourth electrode portion 52 is made of the same material as that of the second electrode portion 51. The fourth electrode portion 52 has an L-shape with the same size as that of the second electrode portion 51, and is positioned at the same position as that of the second electrode portion 51, when the second layer L2 is viewed toward the first negative direction X2. Therefore, the fourth electrode portion 52 is disposed on a surface of the second electrode portion 51 facing the first negative direction X2.

The via 32 is made of the same material as that of the first wiring portion 31. The via 32 has a columnar shape extending in a direction along the first axis X. The via 32 is disposed on a surface of the second end portion 31B of the first wiring portion 31 facing the first negative direction X2. Therefore, the via 32 is electrically connected to the second end portion 31B of the first wiring portion 31. The via 32 extends from the second end portion 31B of the first wiring portion 31 in the first negative direction X2.

A portion of the second layer L2 excluding the third electrode portion 42, the fourth electrode portion 52, and the via 32 is the second insulation portion 22. The second insulation portion 22 is made of a non-magnetic insulator of the same material as that of the first insulation portion 21.

The third layer L3 is disposed on a main surface of the second layer L2 facing the first negative direction X2. The third layer L3 has the same rectangular shape as that of the first layer L1 when the third layer L3 is viewed toward the first negative direction X2. The third layer L3 is composed of a fifth electrode portion 43, a sixth electrode portion 53, a second wiring portion 33, and a third insulation portion 23.

The fifth electrode portion 43 is made of the same material as that of the first electrode portion 41. The fifth electrode portion 43 has an L-shape with the same size as that of the third electrode portion 42, and is positioned at the same position as that of the third electrode portion 42, when the third layer L3 is viewed toward the first negative direction X2. Therefore, the fifth electrode portion 43 is disposed on a surface of the third electrode portion 42 facing the first negative direction X2.

The sixth electrode portion 53 is made of the same material as that of the second electrode portion 51. The sixth electrode portion 53 has an L-shape with the same size as that of the fourth electrode portion 52, and is positioned at the same position as that of the fourth electrode portion 52, when the third layer L3 is viewed toward the first negative direction X2. Therefore, the sixth electrode portion 53 is disposed on a surface of the fourth electrode portion 52 facing the first negative direction X2.

The second wiring portion 33 is made of the same material as that of the first wiring portion 31. The second wiring portion 33, as a whole, spirally extends substantially around a center of the third layer L3, when the third layer L3 is viewed toward the first negative direction X2. Specifically, a position of a first end portion 33A of the second wiring portion 33 is on a surface of the via 32 facing the first negative direction X2. Therefore, the first end portion 33A of the second wiring portion 33 is connected to the via 32. A position of a second end portion 33B of the second wiring portion 33 in the direction along the third axis Z is on the third negative direction Z2 side relative to the center of the third layer L3. A position of the second end portion 33B of the second wiring portion 33 in the direction along the second axis Y is on the second positive direction Y1 side relative to the center of the third layer L3. Further, the position of the second end portion 33B of the second wiring portion 33 in the direction along the second axis Y is on the second negative direction Y2 side of the first end portion 33A of the second wiring portion 33. The second wiring portion 33 extends clockwise from the first end portion 33A to the second end portion 33B, when the second wiring portion 33 is viewed toward the first negative direction X2.

A portion of the third layer L3 excluding the fifth electrode portion 43, the sixth electrode portion 53, and the second wiring portion 33 is the third insulation portion 23. The third insulation portion 23 is made of a non-magnetic insulator of the same material as that of the first insulation portion 21.

The fourth layer L4 is disposed on a main surface of the third layer L3 facing the first negative direction X2. The fourth layer L4 has the same rectangular shape as that of the first layer L1 when the fourth layer L4 is viewed toward the first negative direction X2. The fourth layer L4 is composed of a seventh electrode portion 44, an eighth electrode portion 54, a via 34, and a fourth insulation portion 24.

The seventh electrode portion 44 is made of the same material as that of the first electrode portion 41. The seventh electrode portion 44 has an L-shape with the same size as that of the fifth electrode portion 43, and is positioned at the same position as that of the fifth electrode portion 43, when the fourth layer L4 is viewed toward the first negative direction X2. Therefore, the seventh electrode portion 44 is disposed on a surface of the fifth electrode portion 43 facing the first negative direction X2.

The eighth electrode portion 54 is made of the same material as that of the second electrode portion 51. The eighth electrode portion 54 has an L-shape with the same size as that of the sixth electrode portion 53, and is positioned at the same position as that of the sixth electrode portion 53, when the fourth layer L4 is viewed toward the first negative direction X2. Therefore, the eighth electrode portion 54 is disposed on a surface of the sixth electrode portion 53 facing the first negative direction X2.

The via 34 is made of the same material as that of the first wiring portion 31. The via 34 has a columnar shape extending in the direction along the first axis X. The via 34 is disposed on a surface of the second end portion 33B of the second wiring portion 33 facing the first negative direction X2. Therefore, the via 34 is electrically connected to the second end portion 33B of the second wiring portion 33. The via 34 extends from the second end portion 33B of the second wiring portion 33 in the first negative direction X2.

A portion of the fourth layer L4 excluding the seventh electrode portion 44, the eighth electrode portion 54, and the via 34 is the fourth insulation portion 24. The fourth insulation portion 24 is made of a non-magnetic insulator of the same material as that of the first insulation portion 21.

The fifth layer L5 is disposed on a main surface of the fourth layer L4 facing the first negative direction X2. The fifth layer L5 has the same rectangular shape as that of the first layer L1 when the fifth layer L5 is viewed toward the first negative direction X2. The fifth layer L5 is composed of a ninth electrode portion 45, a tenth electrode portion 55, a third wiring portion 35, and a fifth insulation portion 25.

The ninth electrode portion 45 is made of the same material as that of the first electrode portion 41. The ninth electrode portion 45 has an L-shape with the same size as that of the seventh electrode portion 44, and is positioned at the same position as that of the seventh electrode portion 44, when the fifth layer L5 is viewed toward the first negative direction X2. Therefore, the ninth electrode portion 45 is disposed on a surface of the seventh electrode portion 44 facing the first negative direction X2.

The tenth electrode portion 55 is made of the same material as that of the second electrode portion 51. The tenth electrode portion 55 has an L-shape with the same size as that of the eighth electrode portion 54, and is positioned at the same position as that of the eighth electrode portion 54, when the fifth layer L5 is viewed toward the first negative direction X2. Therefore, the tenth electrode portion 55 is disposed on a surface of the eighth electrode portion 54 facing the first negative direction X2.

The third wiring portion 35 is made of the same material as that of the first wiring portion 31. The third wiring portion 35, as a whole, spirally extends substantially around a center of the fifth layer L5, when the fifth layer L5 is viewed toward the first negative direction X2. Specifically, a position of a first end portion 35A of the third wiring portion 35 is on a surface of the via 34 facing the first negative direction X2. Therefore, the first end portion 35A of the third wiring portion 35 is connected to the via 34. A position of the second end portion 35B of the third wiring portion 35 in the direction along the third axis Z is on the third negative direction Z2 side relative to the center of the fifth layer L5. The position of the second end portion 35B of the third wiring portion 35 in the direction along the second axis Y is on the second negative direction Y2 side relative to the center of the fifth layer L5. The third wiring portion 35 extends clockwise from the first end portion 35A to the second end portion 35B, when the third wiring portion 35 is viewed toward the first negative direction X2.

A portion of the fifth layer L5 excluding the ninth electrode portion 45, the tenth electrode portion 55, and the third wiring portion 35 is the fifth insulation portion 25. The fifth insulation portion 25 is made of a non-magnetic insulator of the same material as that of the first insulation portion 21.

The sixth layer L6 is disposed on a main surface of the fifth layer L5 facing the first negative direction X2. The sixth layer L6 has the same rectangular shape as that of the first layer L1 when the sixth layer L6 is viewed toward the first negative direction X2. The sixth layer L6 is composed of an eleventh electrode portion 46, a twelfth electrode portion 56, a via 36, and a sixth insulation portion 26.

The eleventh electrode portion 46 is made of the same material as that of the first electrode portion 41. The eleventh electrode portion 46 has an L-shape with the same size as that of the ninth electrode portion 45, and is positioned at the same position as that of the ninth electrode portion 45, when the sixth layer L6 is viewed toward the first negative direction X2. Therefore, the eleventh electrode portion 46 is disposed on a surface of the ninth electrode portion 45 facing the first negative direction X2.

The twelfth electrode portion 56 is made of the same material as that of the second electrode portion 51. The twelfth electrode portion 56 has an L-shape with the same size as that of the tenth electrode portion 55, and is positioned at the same position as that of the tenth electrode portion 55, when the sixth layer L6 is viewed toward the first negative direction X2. Therefore, the twelfth electrode portion 56 is disposed on a surface of the tenth electrode portion 55 facing the first negative direction X2.

The via 36 is made of the same material as that of the first wiring portion 31. The via 36 has a columnar shape extending in the direction along the first axis X. The via 36 is disposed on a surface of the second end portion 35B of the third wiring portion 35 facing the first negative direction X2. Therefore, the via 36 is electrically connected to the second end portion 35B of the third wiring portion 35. The via 36 extends from the second end portion 35B of the third wiring portion 35 in the first negative direction X2.

A portion of the sixth layer L6 excluding the eleventh electrode portion 46, the twelfth electrode portion 56, and the via 36 is the sixth insulation portion 26. The sixth insulation portion 26 is made of a non-magnetic insulator of the same material as that of the first insulation portion 21.

The seventh layer L7 is disposed on a main surface of the sixth layer L6 facing the first negative direction X2. The seventh layer L7 has the same rectangular shape as that of the first layer L1 when the seventh layer L7 is viewed toward the first negative direction X2. The seventh layer L7 is composed of a thirteenth electrode portion 47, a fourteenth electrode portion 57, a fourth wiring portion 37, and a seventh insulation portion 27.

The thirteenth electrode portion 47 is made of the same material as that of the first electrode portion 41. The thirteenth electrode portion 47 has an L-shape with the same size as that of the eleventh electrode portion 46, and is positioned at the same position as that of the eleventh electrode portion 46, when the seventh layer L7 is viewed toward the first negative direction X2. Therefore, the thirteenth electrode portion 47 is disposed on a surface of the eleventh electrode portion 46 facing the first negative direction X2.

The fourteenth electrode portion 57 is made of the same material as that of the second electrode portion 51. The fourteenth electrode portion 57 has an L-shape with the same size as that of the twelfth electrode portion 56, and is positioned at the same position as that of the twelfth electrode portion 56, when the seventh layer L7 is viewed toward the first negative direction X2. Therefore, the fourteenth electrode portion 57 is disposed on a surface of the twelfth electrode portion 56 facing the first negative direction X2.

The fourth wiring portion 37 is made of the same material as that of the first wiring portion 31. The fourth wiring portion 37, as a whole, spirally extends substantially around a center of the seventh layer L7, when the seventh layer L7 is viewed toward the first negative direction X2. Specifically, a position of a first end portion 37A of the fourth wiring portion 37 is on a surface of the via 36 facing the first negative direction X2. Therefore, the first end portion 37A of the fourth wiring portion 37 is connected to the via 36. A position of a second end portion 37B of the fourth wiring portion 37 in the direction along the third axis Z is on the third positive direction Z1 side relative to the center of the seventh layer L7. A position of the second end portion 37B of the fourth wiring portion 37 in the direction along the second axis Y is on the second negative direction Y2 side relative to the center of the seventh layer L7, and on the second negative direction Y2 side relative to the first end portion 37A. The fourth wiring portion 37 extends clockwise from the first end portion 37A to the second end portion 37B, when the fourth wiring portion 37 is viewed toward the first negative direction X2. The fourth wiring portion 37 has a shape in which the second wiring portion 33 is inverted in the second positive direction Y1 and the second negative direction Y2.

A portion of the seventh layer L7 excluding the thirteenth electrode portion 47, the fourteenth electrode portion 57, and the fourth wiring portion 37 is the seventh insulation portion 27. The seventh insulation portion 27 is made of a non-magnetic insulator of the same material as that of the first insulation portion 21.

The eighth layer L8 is disposed on a main surface of the seventh layer L7 facing the first negative direction X2. The eighth layer L8 has the same rectangular shape as that of the first layer L1 when the eighth layer L8 is viewed toward the first negative direction X2. The eighth layer L8 is composed of a fifteenth electrode portion 48, a sixteenth electrode portion 58, a via 38, and an eighth insulation portion 28.

The fifteenth electrode portion 48 is made of the same material as that of the first electrode portion 41. The fifteenth electrode portion 48 has an L-shape with the same size as that of the thirteenth electrode portion 47, and is positioned at the same position as that of the thirteenth electrode portion 47, when the eighth layer L8 is viewed toward the first negative direction X2. Therefore, the fifteenth electrode portion 48 is disposed on a surface of the thirteenth electrode portion 47 facing the first negative direction X2.

The sixteenth electrode portion 58 is made of the same material as that of the second electrode portion 51. The sixteenth electrode portion 58 has an L-shape with the same size as that of the fourteenth electrode portion 57, and is positioned at the same position as that of the fourteenth electrode portion 57, when the eighth layer L8 is viewed toward the first negative direction X2. Therefore, the sixteenth electrode portion 58 is disposed on a surface of the fourteenth electrode portion 57 facing the first negative direction X2.

The via 38 is made of the same material as that of the first wiring portion 31. The via 38 has a columnar shape extending in the direction along the first axis X. The via 38 is disposed on a surface of the second end portion 37B of the fourth wiring portion 37 facing the first negative direction X2. Therefore, the via 38 is electrically connected to the second end portion 37B of the fourth wiring portion 37. The via 38 extends from the second end portion 37B of the fourth wiring portion 37 in the first negative direction X2.

A portion of the eighth layer L8 excluding the fifteenth electrode portion 48, the sixteenth electrode portion 58, and the via 38 is the eighth insulation portion 28. The eighth insulation portion 28 is made of a non-magnetic insulator of the same material as that of the first insulation portion 21.

The ninth layer L9 is disposed on a main surface of the eighth layer L8 facing the first negative direction X2. The ninth layer L9 has the same rectangular shape as that of the first layer L1 when the ninth layer L9 is viewed toward the first negative direction X2. The ninth layer L9 is composed of a seventeenth electrode portion 49, an eighteenth electrode portion 59, a fifth wiring portion 39, and a ninth insulation portion 29.

The seventeenth electrode portion 49 is made of the same material as that of the first electrode portion 41. The seventeenth electrode portion 49 has an L-shape with the same size as that of the fifteenth electrode portion 48, and is positioned at the same position as that of the fifteenth electrode portion 48, when the ninth layer L9 is viewed toward the first negative direction X2. Therefore, the seventeenth electrode portion 49 is disposed on a surface of the fifteenth electrode portion 48 facing the first negative direction X2.

The eighteenth electrode portion 59 is made of the same material as that of the second electrode portion 51. The eighteenth electrode portion 59 has an L-shape with the same size as that of the sixteenth electrode portion 58, and is positioned at the same position as that of the sixteenth electrode portion 58, when the ninth layer L9 is viewed toward the first negative direction X2. Therefore, the eighteenth electrode portion 59 is disposed on a surface of the sixteenth electrode portion 58 facing the first negative direction X2.

The fifth wiring portion 39 is made of the same material as that of the first wiring portion 31. The fifth wiring portion 39, as a whole, spirally extends substantially around a center of the ninth layer L9, when the ninth layer L9 is viewed toward the first negative direction X2. Specifically, a position of a first end portion 39A of the fifth wiring portion 39 is on a surface of the via 38 facing the first negative direction X2. Therefore, the first end portion 39A of the fifth wiring portion 39 is connected to the via 38. A second end portion 39B of the fifth wiring portion 39 is a portion deviated from the circulation path formed by the wiring portions of the first layer L1 to the ninth layer L9 overlapping with each other, when viewed toward the first negative direction X2. The second end portion 39B is connected to an end portion of the eighteenth electrode portion 59 on the third positive direction Z1 side in the direction along the third axis Z. The fifth wiring portion 39 extends clockwise from the first end portion 39A to the second end portion 39B, when the fifth wiring portion 39 is viewed toward the first negative direction X2. The second end portion 39B of the fifth wiring portion 39 is the second end of the inductor wiring 30. The fifth wiring portion 39 has a shape in which the first wiring portion 31 is inverted in the second positive direction Y1 and the second negative direction Y2.

A portion of the ninth layer L9 excluding the seventeenth electrode portion 49, the eighteenth electrode portion 59, and the fifth wiring portion 39 is the ninth insulation portion 29. The ninth insulation portion 29 is made of a non-magnetic insulator of the same material as that of the first insulation portion 21.

The element body 11 has a first covering insulation layer 61 and a second covering insulation layer 62. The first covering insulation layer 61 has the same rectangular shape as that of the first layer L1 when the first covering insulation layer 61 is viewed toward the first negative direction X2. The first covering insulation layer 61 is disposed on a main surface of the first layer L1 facing the first positive direction X1. The second covering insulation layer 62 has the same rectangular shape as that of the first layer L1 when the second covering insulation layer 62 is viewed toward the first positive direction X1. The second covering insulation layer 62 is disposed on a main surface of the ninth layer L9 facing the first negative direction X2. Note that the first covering insulation layer 61 may be formed by laminating multiple insulation layers. Further, some layers in the insulation layers may be colored. This also applies to the second covering insulation layer 62.

The first insulation portion 21 to the ninth insulation portion 29, the first covering insulation layer 61, and the second covering insulation layer 62 described above are integrated. Therefore, there may be no physical boundary between the first insulation portion 21 to the ninth insulation portion 29, the first covering insulation layer 61, and the second covering insulation layer 62. Hereinafter, when there is no need to distinguish, they are collectively referred to as an insulation portion 20.

Further, the first wiring portion 31, the second wiring portion 33, the third wiring portion 35, the fourth wiring portion 37, the fifth wiring portion 39, the via 32, the via 34, the via 36, and the via 38 are integrated. Therefore, there may be no physical boundary between the via 32 to via 38. Hereinafter, when there is no need to distinguish, they are collectively referred to as the inductor wiring 30. The inductor wiring 30, as a whole, is spirally wound. A central axis of a winding in the inductor wiring 30 is an axis along the first axis X.

Furthermore, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 described above are integrated. These are integrated to form the first electrode 40.

Similarly, the second electrode portion 51, the fourth electrode portion 52, the sixth electrode portion 53, the eighth electrode portion 54, the tenth electrode portion 55, the twelfth electrode portion 56, the fourteenth electrode portion 57, the sixteenth electrode portion 58, and the eighteenth electrode portion 59 described above are integrated. These are integrated to form the second electrode 50.

In the present embodiment, the insulation portion 20, the first electrode 40, and the second electrode 50 constitute the element body 11 of the inductor component 10. The inductor wiring 30 extends inside the element body 11. Note that the inductor wiring 30, the first electrode 40, and the second electrode 50 may be integrated. Therefore, there may be no physical boundary between the inductor wiring 30 and the first electrode 40, and between the inductor wiring 30 and the second electrode 50.

As a result of the first layer L1 to the ninth layer L9, the first covering insulation layer 61, and the second covering insulation layer 62 being stacked, the element body 11, as a whole, has a rectangular shape as illustrated in FIG. 1. The first electrode 40 is exposed to the outside of the element body 11 in a region straddling the first end surface 11C and the bottom surface 11E as illustrated in FIG. 3. Further, the second electrode 50 is exposed to the outside of the element body 11 in a region straddling the second end surface 11D and the bottom surface 11E.

The inductor component 10 includes a first covering electrode 71 and a second covering electrode 72 as illustrated in FIG. 1. The first covering electrode 71 covers a surface of the first electrode 40 exposed to the outside from the element body 11. Although not illustrated, the first covering electrode 71 has a two-layer structure of nickel plating and tin plating. The portion where the first electrode 40 is exposed to the outside from the element body 11 is a portion of the first electrode 40 not covered by the element body 11. Therefore, even when the first electrode 40 is covered by another layer, it is expressed that the first electrode 40 is exposed to the outside from the element body 11.

The second covering electrode 72 covers a surface of the second electrode 50 exposed to the outside from the element body 11. Although not illustrated, the second covering electrode 72 has a two-layer structure of nickel plating and tin plating. Note that, in FIG. 2 and subsequent figures, the first covering electrode 71 and the second covering electrode 72 are not illustrated.

Shape of Inductor Wiring

The inductor wiring 30, as a whole, has a spiral shape as illustrated in FIG. 2. Here, a portion of the inductor wiring 30 extending in a spiral shape is referred to as a winding portion 30A. In other words, an annular portion in which turns of the inductor wiring 30 overlap with each other is defined as the winding portion 30A when viewed in a direction perpendicular to the first main surface 11A.

Part of the first wiring portion 31 of the first layer L1 including the first end portion 31A is not included in the winding portion 30A as illustrated in FIG. 2. Further, part of the fifth wiring portion 39 of the ninth layer L9 including the second end portion 39B is not included in the winding portion 30A. Therefore, the winding portion 30A has an annular shape when viewed through the inductor component 10 toward the first negative direction X2. In the following description, boundaries between the first wiring portion 31 to the fifth wiring portion 39 are omitted, and it is assumed that the winding portion 30A has an annular shape. In FIG. 3, only the winding portion 30A of the inductor wiring 30 is illustrated, and the vias 32, 34, 36, and 38 are not illustrated.

The winding portion 30A has an upper side portion 301, a lower side portion 302, a first lateral side portion 304A, and a second lateral side portion 304B as illustrated in FIG. 3. The winding portion 30A has a first protrusion portion 320A and a second protrusion portion 320B.

The upper side portion 301 is a portion of the winding portion 30A closest to the top surface 11F among portions parallel to the top surface 11F. That is, the upper side portion 301 extends along the second axis Y. The upper side portion 301 is positioned on the third positive direction Z1 side relative to a center of the element body 11 in the direction along the third axis Z. A first end of the upper side portion 301 is positioned on the second positive direction Y1 side relative to the center of the element body 11 in the direction along the second axis Y. A second end of the upper side portion 301 is positioned on the second negative direction Y2 side relative to the center of the element body 11 in the direction along the second axis Y. Further, a position at which a length of the upper side portion 301 is divided in half in the direction along the second axis Y is positioned substantially at a center of the element body 11 in the direction along the second axis Y. A line width of the upper side portion 301 is constant.

Note that a line width is defined as follows. That is, the shortest line segment is specified among line segments that can be drawn from an arbitrary point on an edge of certain wiring to an edge on the opposite side. A length of the specified line segment is the line width of the wiring at the arbitrary point. Further, a line width being constant includes an error in manufacturing and the like. That is, a line width being constant means that a difference from an average value of a line width of wiring is 20% or less of the average value.

The lower side portion 302 has a first lower side portion 302A, a second lower side portion 303A, and a third lower side portion 303B.

The first lower side portion 302A extends parallel to the bottom surface 11E at a position closest to the bottom surface 11E. The first lower side portion 302A is positioned on the third negative direction Z2 side relative to the center of the element body 11 in the direction along the third axis Z, when viewed toward the first negative direction X2 perpendicular to the first main surface 11A. That is, the first lower side portion 302A is positioned closer to the bottom surface 11E than the upper side portion 301. A first end of the first lower side portion 302A is positioned on the second positive direction Y1 side relative to the center of the element body 11 in the direction along the second axis Y. Further, the first end of the first lower side portion 302A is positioned on the second negative direction Y2 side relative to a position of the first end of the upper side portion 301 in the direction along the second axis Y. A second end of the first lower side portion 302A is positioned on the second negative direction Y2 side relative to the center of the element body 11 in the direction along the second axis Y. Further, the second end of the first lower side portion 302A is positioned on the second positive direction Y1 side relative to a position of the second end of the upper side portion 301 in the direction along the second axis Y. Further, a position at which a length of the first lower side portion 302A is divided in half in the direction along the second axis Y is positioned substantially at the center of the element body 11 in the direction along the second axis Y.

The second lower side portion 303A has a linear shape when viewed toward the first negative direction X2. Note that, when an edge on one side of wiring and an edge on an opposite side thereof are both straight lines and are parallel to each other, it can be said that the wiring extends linearly. A first end of the second lower side portion 303A is connected to the first end of the first lower side portion 302A. The second lower side portion 303A linearly extends from the first lower side portion 302A of the winding portion 30A closest to the bottom surface 11E to the same position as that of an end of the upper side portion 301 facing the first end surface 11C, in a direction perpendicular to the first end surface 11C. That is, the position of a second end of the second lower side portion 303A is the same as the position of the first end of the upper side portion 301 in the direction along the second axis Y. Note that, in FIG. 3, a boundary between the second lower side portion 303A and the first lower side portion 302A is virtually indicated by a broken line.

The first lateral side portion 304A connects an end of the second lower side portion 303A facing the first end surface 11C and the end of the upper side portion 301 facing the first end surface 11C. That is, the first lateral side portion 304A connects the second end of the second lower side portion 303A and the first end of the upper side portion 301. Note that, in FIG. 3, a boundary between the first lateral side portion 304A and the second lower side portion 303A, and a boundary between the first lateral side portion 304A and the upper side portion 301 each are virtually indicated by a broken line.

The first lateral side portion 304A extends in an arc shape protruding toward the first end surface 11C when viewed toward the first negative direction X2. Further, the entire first lateral side portion 304A has an arc shape. That is, the entire first lateral side portion 304A is positioned between the first end of the upper side portion 301 facing the first end surface 11C and the first end surface 11C. In other words, the entire first lateral side portion 304A is positioned closer to the first end surface 11C than is the end of the upper side portion 301 facing the first end surface 11C. Note that a point N1 of the first lateral side portion 304A closest to the first end surface 11C is positioned closer to the top surface 11F than is an end of the first electrode 40 on the third positive direction Z1 side.

The third lower side portion 303B has a linear shape when viewed toward the first negative direction X2. A first end of the third lower side portion 303B is connected to the second end of the first lower side portion 302A. The third lower side portion 303B linearly extends from the first lower side portion 302A of the winding portion 30A closest to the bottom surface 11E to the same position as that of an end of the upper side portion 301 facing the second end surface 11D, in a direction perpendicular to the second end surface 11D. That is, the position of a second end of the third lower side portion 303B is the same as the position of the second end of the upper side portion 301 in the direction along the second axis Y. Note that, in FIG. 3, a boundary between the third lower side portion 303B and the first lower side portion 302A is virtually indicated by a broken line.

The second lateral side portion 304B connects an end of the third lower side portion 303B facing the second end surface 11D and the end of the upper side portion 301 facing the second end surface 11D. That is, the second lateral side portion 304B connects the second end of the third lower side portion 303B and the second end of the upper side portion 301. Note that, in FIG. 3, a boundary between the second lateral side portion 304B and the third lower side portion 303B, and a boundary between the second lateral side portion 304B and the upper side portion 301 each are virtually indicated by a broken line.

The second lateral side portion 304B extends in an arc shape protruding toward the second end surface 11D when viewed toward the first negative direction X2. Further, the entire second lateral side portion 304B has an arc shape. That is, the entire second lateral side portion 304B is positioned between the second end of the upper side portion 301 facing the second end surface 11D and the second end surface 11D. In other words, the entire second lateral side portion 304B is positioned closer to the second end surface 11D than is the end of the upper side portion 301 facing the second end surface 11D. Note that a point N2 of the second lateral side portion 304B closest to the second end surface 11D is positioned closer to the top surface 11F than is an end of the second electrode 50 on the third positive direction Z1 side. The line width of the second lateral side portion 304B is the same as the line width of the upper side portion 301.

In the configuration described above, part of the lower side portion 302 in the winding portion 30A extends from a position closest to the bottom surface 11E to the same position as the end of the upper side portion 301 facing the first end surface 11C, in the direction perpendicular to the first end surface 11C. Similarly, part of the lower side portion 302 extends from a position closest to the bottom surface 11E to the same position as the end of the upper side portion 301 facing the second end surface 11D, in the direction perpendicular to the second end surface 11D.

The winding portion 30A includes a wiring main body 310 extending with a constant line width. The wiring main body 310 is substantially an entire portion including the upper side portion 301, the lower side portion 302, the first lateral side portion 304A, and the second lateral side portion 304B. However, the line width is not constant in the vicinity of a connection point of the portions. That is, the vicinity of the connection point of the portions is not the wiring main body 310.

The first protrusion portion 320A protrudes from an edge of the wiring main body 310 toward the first end surface 11C. That is, the first protrusion portion 320A protrudes from an outer peripheral side of the winding portion 30A. The first protrusion portion 320A is straddling both the first lateral side portion 304A and the second lower side portion 303A. The first protrusion portion 320A has a semi-circular shape when viewed toward the first negative direction X2. Specifically, the first protrusion portion 320A has a semi-circular shape protruding toward the first end surface 11C and the bottom surface 11E.

The second protrusion portion 320B protrudes from the edge of the wiring main body 310 toward the second end surface 11D. That is, the second protrusion portion 320B protrudes from the outer peripheral side of the winding portion 30A. The second protrusion portion 320B is straddling both the second lateral side portion 304B and the third lower side portion 303B. The second protrusion portion 320B has a semi-circular shape when viewed toward the first negative direction X2. Specifically, the second protrusion portion 320B has a semi-circular shape protruding toward the second end surface 11D and the bottom surface 11E.

Shape of First Electrode and Second Electrode

The first electrode 40 includes a first bottom surface electrode portion 401 and a first end surface electrode portion 402.

The first bottom surface electrode portion 401 has a triangular shape when viewed toward the first negative direction X2 as illustrated in FIG. 3. One side of the first bottom surface electrode portion 401 extends from a boundary between the first end surface 11C and the bottom surface 11E. The above-described side of the first bottom surface electrode portion 401 is part of the bottom surface 11E. That is, the first bottom surface electrode portion 401 is exposed to the outside of the element body 11 in a region including a boundary portion of the bottom surface 11E with the first end surface 11C.

Here, the size of the first bottom surface electrode portion 401 in a direction perpendicular to the bottom surface 11E is defined as a thickness P1 of the first bottom surface electrode portion 401, when viewed toward the first negative direction X2. A portion of the first bottom surface electrode portion 401 farthest from the first end surface 11C is defined as a leading end PY. The thickness P1 of the first bottom surface electrode portion 401 continuously increases at a constant gradient as it extends farther from the first end surface 11C, in a partial section extending from the boundary between the first end surface 11C and the bottom surface 11E toward the second negative direction Y2. The section in which the thickness P1 increases is a section overlapping with the first end surface electrode portion 402 described later in the direction along the second axis Y. The thickness P1 of the first bottom surface electrode portion 401 increases in the partial section above, and then continuously decreases toward the leading end PY with a constant gradient. That is, the thickness P1 of at least part of the first bottom surface electrode portion 401 including the leading end PY decreases toward the leading end PY. Further, the thickness P1 decreases toward the leading end PY over an entire section not overlapping with the first end surface electrode portion 402 in the direction along the second axis Y. Note that, in FIG. 3, a region of the first electrode 40 being the first bottom surface electrode portion 401 is indicated by a dot.

The first end surface electrode portion 402 has a triangular shape when viewed toward the first negative direction X2. One side of the first end surface electrode portion 402 extends from the boundary between the first end surface 11C and the bottom surface 11E. The above-described side of the first end surface electrode portion 402 is part of the first end surface 11C. That is, the first end surface electrode portion 402 is exposed to the outside of the element body 11 in a region including a boundary portion of the first end surface 11C with the bottom surface 11E.

Here, the size of the first end surface electrode portion 402 in the direction perpendicular to the first end surface 11C is defined as a thickness P2 of the first end surface electrode portion 402, when viewed toward the first negative direction X2. A portion of the first end surface electrode portion 402 farthest from the bottom surface 11E is defined as a leading end PZ. The thickness P2 of the first end surface electrode portion 402 continuously increases at a constant gradient as it extends farther from the bottom surface 11E, in a partial section extending from the boundary between the first end surface 11C and the bottom surface 11E toward the third positive direction Z1. The section in which the thickness P2 increases is a section overlapping with the first bottom surface electrode portion 401 described above in the direction along the third axis Z. The thickness P2 of the first end surface electrode portion 402 increases in the partial section above, and then continuously decreases toward the leading end PZ with a constant gradient. That is, the thickness P2 of at least part of the first end surface electrode portion 402 including the leading end PZ decreases toward the leading end PZ. Further, the thickness P2 decreases toward the leading end PZ over an entire section not overlapping with the first bottom surface electrode portion 401 in the direction along the third axis Z. Note that, in FIG. 3, a region of the first electrode 40 being the first end surface electrode portion 402 is indicated by a dot finer than that of the first bottom surface electrode portion 401. Actually, there is no physical boundary between the first bottom surface electrode portion 401 and the first end surface electrode portion 402.

The second electrode 50 includes a second bottom surface electrode portion 501 and a second end surface electrode portion 502.

The second bottom surface electrode portion 501 has a triangular shape when viewed toward the first negative direction X2 as illustrated in FIG. 3. One side of the second bottom surface electrode portion 501 extends from a boundary between the second end surface 11D and the bottom surface 11E. The above-described side of the second bottom surface electrode portion 501 is part of the bottom surface 11E. That is, the second bottom surface electrode portion 501 is exposed to the outside of the element body 11 in a region including a boundary portion of the bottom surface 11E with the second end surface 11D.

Here, the size of the second bottom surface electrode portion 501 in the direction perpendicular to the bottom surface 11E is defined as a thickness Q1 of the second bottom surface electrode portion 501, when viewed toward the first negative direction X2. A portion of the second bottom surface electrode portion 501 farthest from the second end surface 11D is defined as a leading end QY. The thickness Q1 of the second bottom surface electrode portion 501 continuously increases at a constant gradient as it extends farther from the second end surface 11D, in a partial section extending from the boundary between the second end surface 11D and the bottom surface 11E toward the second positive direction Y1. The section in which the thickness Q1 increases is a section overlapping with the second end surface electrode portion 502 described later in the direction along the second axis Y. The thickness Q1 of the second bottom surface electrode portion 501 increases in the partial section above, and then continuously decreases toward the leading end QY with a constant gradient. That is, the thickness Q1 of at least part of the second bottom surface electrode portion 501 including the leading end QY decreases toward the leading end QY. Further, the thickness Q1 decreases toward the leading end QY over an entire section not overlapping with the second end surface electrode portion 502 in the direction along the second axis Y. Note that, in FIG. 3, a region of the second electrode 50 being the second bottom surface electrode portion 501 is indicated by a dot.

The second end surface electrode portion 502 has a triangular shape when viewed toward the first negative direction X2. One side of the second end surface electrode portion 502 extends from the boundary between the second end surface 11D and the bottom surface 11E. The above-described side of the second end surface electrode portion 502 is part of the second end surface 11D. That is, the second end surface electrode portion 502 is exposed to the outside of the element body 11 in a region including a boundary portion of the second end surface 11D with the bottom surface 11E.

Here, the size of the second end surface electrode portion 502 in the direction perpendicular to the second end surface 11D is defined as a thickness Q2 of the second end surface electrode portion 502, when viewed toward the first negative direction X2. A portion of the second end surface electrode portion 502 farthest from the bottom surface 11E is defined as a leading end QZ. The thickness Q2 of the second end surface electrode portion 502 continuously increases at a constant gradient as it extends farther from the bottom surface 11E, in a partial section extending from the boundary between the second end surface 11D and the bottom surface 11E toward the third positive direction Z1. The section in which the thickness Q2 increases is a section overlapping with the second bottom surface electrode portion 501 described above in the direction along the third axis Z. The thickness Q2 of the second end surface electrode portion 502 increases in the partial section above, and then continuously decreases toward the leading end QZ with a constant gradient. That is, the thickness Q2 of at least part of the second end surface electrode portion 502 including the leading end QZ decreases toward the leading end QZ. Further, the thickness Q2 decreases toward the leading end QZ over an entire section not overlapping with the second bottom surface electrode portion 501 in the direction along the third axis Z. Note that, in FIG. 3, a region of the second electrode 50 being the second end surface electrode portion 502 is indicated by a dot finer than that of the second bottom surface electrode portion 501. Actually, there is no physical boundary between the second bottom surface electrode portion 501 and the second end surface electrode portion 502.

Effect of Inductor Component of First Embodiment

According to the first embodiment described above, the following effects are achieved. Note that effects common to the first electrode 40 and the second electrode 50 will be described using the first electrode 40 as a representative. Effects common to the first lateral side portion 304A and the second lateral side portion 304B will be described using the first lateral side portion 304A as a representative.

(1-1) In the first embodiment described above, the thickness P1 of at least part of the first bottom surface electrode portion 401 including the leading end PY decreases toward the leading end PY. With the use of the configuration above, a region in which the inductor wiring 30 may be disposed is increased by an amount corresponding to a decrease in the thickness P1 of the first bottom surface electrode portion 401. Therefore, with the use of the configuration above, a diameter of the winding portion 30A of the inductor component 10 may be designed to be larger. In the inductor component 10, an increase in an inductance value may be expected by designing the diameter of the winding portion 30A to be larger.

(1-2) In the first embodiment described above, the thickness P1 of the first bottom surface electrode portion 401 continuously decreases at a constant gradient toward the leading end PY over the entire section not overlapping with the first end surface electrode portion 402 in the direction along the second axis Y. In a case of the configuration above, the diameter of the winding portion 30A may be designed to be larger in comparison with a case that the thickness P1 of part of a section not overlapping with the first end surface electrode portion 402, in the direction along the second axis Y, is constant. That is, in the configuration above, the inductor component 10 may be expected to have an increased inductance value.

(1-3) In the first embodiment described above, the thickness P2 of at least part of the first end surface electrode portion 402 including the leading end PZ decreases toward the leading end PZ. With the use of the configuration above, a region in which the inductor wiring 30 may be disposed is increased by an amount corresponding to a decrease in the thickness P2 of the first end surface electrode portion 402. Therefore, with the use of the configuration above, a diameter of the winding portion 30A of the inductor component 10 may be designed to be larger. In the inductor component 10, an increase in an inductance value may be expected by designing the diameter of the winding portion 30A to be larger.

(1-4) In the first embodiment described above, the thickness P2 of the first end surface electrode portion 402 continuously decreases at a constant gradient toward the leading end PZ over the entire section not overlapping with the first bottom surface electrode portion 401 in the direction along the third axis Z. In a case of the configuration above, the diameter of the winding portion 30A may be designed to be larger in comparison with a case that the thickness P2 of part of a section not overlapping with the first bottom surface electrode portion 401, in the direction along the third axis Z, is constant. That is, in the configuration above, the inductor component 10 may be expected to have an increased inductance value.

(1-5) In the first embodiment described above, the entire first lateral side portion 304A is positioned closer to the first end surface 11C than is the end of the upper side portion 301 facing the first end surface 11C. The diameter of the winding portion 30A may be made larger, compared with a configuration, for example, in which the first lateral side portion 304A extends parallel to the first end surface 11C. Therefore, according to the first embodiment, an increase in an inductance value of the inductor component 10 may be expected. Further, being connected to the upper side portion 301, the first lateral side portion 304A is positioned relatively close to the top surface 11F in the element body 11. Therefore, the first lateral side portion 304A is unlikely to overlap with the first electrode 40 in the direction along the third axis Z. That is, in the first embodiment, the diameter of the winding portion 30A is made larger with the first lateral side portion 304A being unlikely to overlap with the first electrode 40. As a result, according to the first embodiment, an increase in an inductance value may be achieved while suppressing a decrease in a Q factor.

(1-6) In the first embodiment described above, the first lateral side portion 304A extends in an arc shape protruding toward the first end surface 11C. With the use of the configuration above, a clear corner at which straight lines meet does not occur at a connection portion of the upper side portion 301 and the first lateral side portion 304A. Similarly, a clear corner does not occur at a connection portion of the first lateral side portion 304A and the second lower side portion 303A. Thus, electricity acquisition efficiency of the inductor component 10 is less likely to be impaired. As a result, improvement in Q characteristics of the inductor component 10 may be expected.

(1-7) In the first embodiment described above, the point N1 of the first lateral side portion 304A closest to the first end surface 11C is positioned closer to the top surface 11F than is the end of the first electrode 40 on the third positive direction Z1 side. With the use of the configuration above, the point N1 of the first lateral side portion 304A closest to the first end surface 11C does not overlap with the first electrode 40 in the direction along the third axis Z, when viewed toward the first negative direction X2. Therefore, occurrence of excessively large stray capacitance between the first lateral side portion 304A and the first electrode 40 may be prevented.

(1-8) In the first embodiment described above, the inductor wiring 30 has the wiring main body 310 extending with a constant line width and the first protrusion portion 320A protruding from the edge of the wiring main body 310. With the use of the configuration above, a decrease in electrical resistance may be expected in the first protrusion portion 320A. Therefore, in the inductor component 10 of the first embodiment, improvement of the Q characteristics may be expected. In the respect above, the same effect may be obtained in the second protrusion portion 320B.

### Second Embodiment

Next, a second embodiment of the inductor component 10 will be described. The inductor component 10 of the second embodiment is different in the configuration relating to the first electrode 40 and the second electrode 50, in comparison with the inductor component 10 of the first embodiment. Other configurations are the same as those of the first embodiment. Hereinafter, portions related to the first electrode 40 and the second electrode 50 will be described. Note that a description of the same configuration as that of the first embodiment will be simplified or omitted.

The first electrode 40 includes a first bottom surface electrode portion 401 and a first end surface electrode portion 402 as illustrated in FIG. 4.

The thickness P1 of the first bottom surface electrode portion 401 continuously increases at a constant gradient as it extends farther from the first end surface 11C, in a partial section extending from the boundary between the first end surface 11C and the bottom surface 11E toward the second negative direction Y2. The section in which the thickness P1 increases is a section overlapping with the first end surface electrode portion 402 described later in the direction along the second axis Y. A portion positioned farthest in the second negative direction Y2 in a section where the thickness P1 becomes larger has the maximum thickness P1.

The thickness P1 of the first bottom surface electrode portion 401 increases in the partial section above, and then decreases stepwise toward the leading end PY. That is, in the thickness P1 of the first bottom surface electrode portion 401, a section of a constant thickness P1 and a section of a constant thickness P1 smaller than the preceding section are repeated toward the leading end PY. This size relationship continues up to the leading end PY. That is, the thickness P1 is the smallest at a portion including the leading end PY. Note that, in FIG. 4, a region of the first electrode 40 being the first bottom surface electrode portion 401 is indicated by a dot.

The thickness P2 of the first end surface electrode portion 402 continuously increases at a constant gradient as it extends farther from the bottom surface 11E, in a partial section extending from the boundary between the first end surface 11C and the bottom surface 11E toward the third positive direction Z1. The section in which the thickness P2 increases is a section overlapping with the first bottom surface electrode portion 401 in the direction along the third axis Z. A portion positioned farthest in the third positive direction Z1 in a section where the thickness P2 becomes larger has the maximum thickness P2.

The thickness P2 of the first end surface electrode portion 402 increases in the partial section above, and then decreases stepwise toward the leading end PZ. Further, the thickness P2 is the smallest at a portion including the leading end PZ. Note that, in FIG. 4, a region of the first electrode 40 being the first end surface electrode portion 402 is indicated by a dot finer than that of the first bottom surface electrode portion 401. Actually, there is no physical boundary between the first bottom surface electrode portion 401 and the first end surface electrode portion 402.

The second electrode 50 includes a second bottom surface electrode portion 501 and a second end surface electrode portion 502.

The thickness Q1 of the second bottom surface electrode portion 501 continuously increases at a constant gradient as it extends farther from the second end surface 11D, in a partial section extending from the boundary between the second end surface 11D and the bottom surface 11E toward the second positive direction Y1 as illustrated in FIG. 4. The section in which the thickness Q1 increases is a section overlapping with the second end surface electrode portion 502 described later in the direction along the second axis Y. A portion positioned farthest in the second positive direction Y1 in a section where the thickness Q1 becomes larger has the maximum thickness Q1.

The thickness Q1 of the second bottom surface electrode portion 501 increases in the partial section above, and then decreases stepwise toward the leading end QY. This size relationship continues up to the leading end QY. That is, the thickness Q1 is the smallest at a portion including the leading end QY. Note that, in FIG. 4, a region of the second electrode 50 being the second bottom surface electrode portion 501 is indicated by a dot.

The thickness Q2 of the second end surface electrode portion 502 continuously increases at a constant gradient as it extends farther from the bottom surface 11E, in a partial section extending from the boundary between the second end surface 11D and the bottom surface 11E toward the third positive direction Z1. The section in which the thickness Q2 increases is a section overlapping with the second bottom surface electrode portion 501 in the direction along the third axis Z. A portion positioned farthest in the third positive direction Z1 in a section where the thickness Q2 becomes larger has the maximum thickness Q2.

The thickness Q2 of the second end surface electrode portion 502 increases in the partial section above, and then decreases stepwise toward the leading end QZ. Further, the thickness Q2 is the smallest at a portion including the leading end QZ. Note that, in FIG. 4, a region of the second electrode 50 being the second end surface electrode portion 502 is indicated by a dot finer than that of the second bottom surface electrode portion 501. Actually, there is no physical boundary between the second bottom surface electrode portion 501 and the second end surface electrode portion 502.

Effect of Inductor Component of Second Embodiment

The inductor component 10 of the second embodiment described above achieves the same effects as (1-1) to (1-8) of the first embodiment. Furthermore, the inductor component 10 of the second embodiment achieves the following effects. Note that effects common to the first electrode 40 and the second electrode 50 will be described using the first electrode 40 as a representative.

(2-1) The first bottom surface electrode portion 401 of the second embodiment described above has a larger area in contact with the insulation portion 20 in a region where the thickness P1 decreases stepwise in comparison with the configuration of the first embodiment. As the area in contact increases, adhesion strength between the insulation portion 20 and the first bottom surface electrode portion 401 increases. Therefore, with the use of the configuration described above, the first bottom surface electrode portion 401 is hardly peeled off from the insulation portion 20.

(2-2) The first end surface electrode portion 402 of the second embodiment described above has a larger area in contact with the insulation portion 20 in a region where the thickness P2 decreases stepwise in comparison with the configuration of the first embodiment. That is, with the use of the configuration described above, in the same way as the first bottom surface electrode portion 401, the first end surface electrode portion 402 is hardly peeled off from the insulation portion 20.

Modifications

The embodiments described above may be modified as follows. The embodiments described above and the following modifications may be combined with each other as long as no technical contradiction arises. Note that points common to the first electrode 40 and the second electrode 50 will be described using the first electrode 40 as a representative example, and a description of the second electrode 50 will be omitted.

All of the thicknesses of the first layer L1 to the ninth layer L9, that is, all of the sizes thereof in the direction along the first axis X, need not be the same. All of the thicknesses may be different from each other, or thicknesses of some layers may be different from thicknesses of other layers.

The element body 11 may be a rectangular parallelepiped being long in the direction along the first axis X, or may be a rectangular parallelepiped being long in the direction along the third axis Z. Further, the element body 11 may be a rectangular parallelepiped in which the size in the direction along the first axis X, the size in the direction along the second axis Y, and the size in the direction along the third axis Z are equal to each other.

A material of the insulation portion 20 is not limited to the example of the embodiment described above, but is required to be an insulator. For example, the material of the insulation portion 20 may be a magnetic insulator. Further, part of the insulation portion 20 may be a non-magnetic or magnetic insulator different from the other portion.

The first covering electrode 71 and the second covering electrode 72 may be constituted by only one layer, or may be constituted by three or more layers. Further, any material, as long as being conductive, may be adopted as a material of each layer in the first covering electrode 71 and the second covering electrode 72. Furthermore, the first covering electrode 71 and the second covering electrode 72 may be omitted.

The first protrusion portion 320A may protrude from an inner peripheral side of the winding portion 30A. This also applies to the second protrusion portion 320B.

The shape of the first protrusion portion 320A when viewed toward the first negative direction X2 is not limited to a semi-circular shape. The first protrusion portion 320A may have a polygonal shape or other shapes, for example.

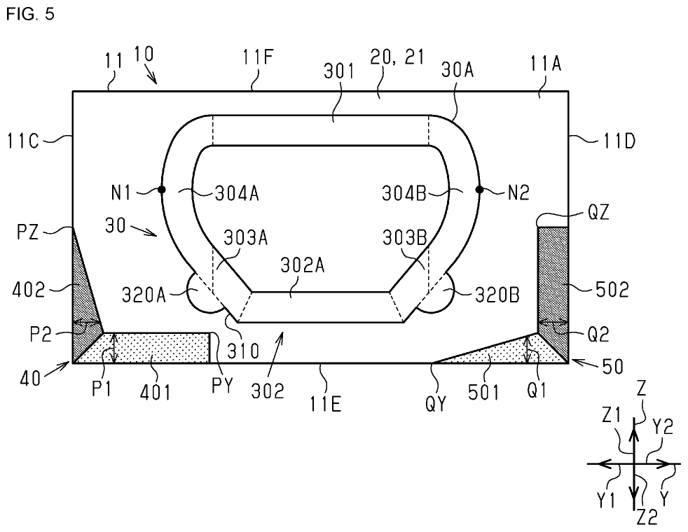

The shape of the first electrode 40 is not limited as long as the thickness P1 of at least part of the first bottom surface electrode portion 401 including the leading end PY decreases toward the leading end PY. Further, the shape is not limited as long as the thickness P2 of at least part of the first end surface electrode portion 402 including the leading end PZ decreases toward the leading end PZ. It is sufficient that the first electrode 40 satisfies at least one of the two conditions described above. An example illustrated in FIG. 5 may be used, for example. In the example illustrated in FIG. 5, the thickness P1 of the first bottom surface electrode portion 401 continuously increases at a constant gradient as it extends farther from the first end surface 11C, in a partial section extending from the boundary between the first end surface 11C and the bottom surface 11E toward the second negative direction Y2. The thickness P1 of the first bottom surface electrode portion 401 is constant from a portion at which the thickness P1 is increased to the largest in the partial section above to the leading end PY. Further, the first end surface electrode portion 402 has the same shape as that of the example of the first embodiment. As described above, it is sufficient that the inductor component 10 satisfies either one of the above two conditions.

In the example illustrated in FIG. 5, the second bottom surface electrode portion 501 has the same shape as that of the example of the first embodiment. The thickness Q2 of the second end surface electrode portion 502 continuously increases at a constant gradient as it extends farther from the bottom surface 11E, in a partial section extending from the boundary between the second end surface 11D and the bottom surface 11E toward the third positive direction Z1. The thickness Q2 of the second end surface electrode portion 502 is constant from a portion at which the thickness Q2 is increased to the largest in the partial section above to the leading end QZ. As described above, the first bottom surface electrode portion 401 and the second bottom surface electrode portion 501 need not have symmetrical shapes. Similarly, the first end surface electrode portion 402 and the second end surface electrode portion 502 need not have symmetrical shapes.

Further, in the example illustrated in FIG. 5, the first electrode 40 may have a portion at least part of which includes the leading end PY, becoming smaller toward the leading end PY, in addition to a portion where the thickness P1 of the first bottom surface electrode portion 401 is constant. The same applies to the first end surface electrode portion 402, the second bottom surface electrode portion 501, and the second end surface electrode portion 502.

In the embodiment described above, in the first electrode 40, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 have the same shape, but are not required to have the same shape. It is sufficient that, in at least one electrode portion among the first electrode portion 41 to the seventeenth electrode portion 49, the thickness of at least one of the leading end of the bottom surface electrode portion and the leading end of the end surface electrode portion decreases toward the leading end, for example. In the case above, the winding diameter may be increased in the wiring portion disposed in the same layer as the electrode portion becoming smaller toward the leading end.

Note that, at this time, in the electrode portion becoming smaller toward the leading end, the thickness of both the bottom surface electrode portion and the end surface electrode portion may become smaller toward the leading end. Further, in the electrode portion becoming smaller toward the leading end, the thickness of one of the bottom surface electrode portion and the end surface electrode portion may become smaller toward the leading end, and the other may have a completely different shape. Further, other electrode portions may have the same shape or different shapes. For example, in multiple electrode portions among other electrode portions, the thickness of at least one of the bottom surface electrode portion and the end surface electrode portion may become smaller toward the leading end. Further, for example, in all other electrodes, the thicknesses of the bottom surface electrode portion and the end surface electrode portion may be constant. Furthermore, the second electrode 50 may have the same structure as described above.

In the first embodiment and the second embodiment, the first protrusion portion 320A and the second protrusion portion 320B may be omitted. Also, in the configuration above, effects other than (1-8) described above may be obtained.

The upper side portion 301, the lower side portion 302, the first lateral side portion 304A, and the second lateral side portion 304B may have different line widths, respectively.

The shape of the winding portion 30A of the inductor wiring 30 may be different from the example of the embodiments described above. For example, in each of the embodiments described above, the entire first lateral side portion 304A need not be positioned between the end of the upper side portion 301 facing the first end surface 11C and the first end surface 11C. As long as at least part of the first lateral side portion 304A is positioned between the end of the upper side portion 301 facing the first end surface 11C and the first end surface 11C, an effect similar to the effect described in (1-5) may be obtained.

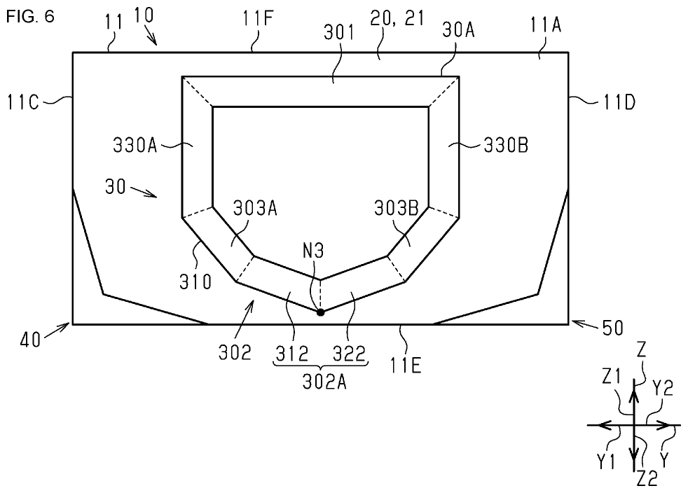

For example, the winding portion 30A may have a shape illustrated in FIG. 6. In the example illustrated in FIG. 6, the winding portion 30A has an upper side portion 301 and a lower side portion 302. The lower side portion 302 has a first lower side portion 302A, a second lower side portion 303A, a third lower side portion 303B, a first lateral lower side portion 330A, and a second lateral lower side portion 330B. That is, the lower side portion 302 includes a point N3 closest to the bottom surface 11E in the winding portion 30A.

A first end of the first lateral lower side portion 330A illustrated in FIG. 6 is connected to an end of the upper side portion 301 facing the first end surface 11C. A second end of the first lateral lower side portion 330A is positioned at the same position as the end of the upper side portion 301 facing the first end surface 11C in the direction along the second axis Y, and is positioned on the third negative direction Z2 side relative to the first end described above. That is, the first lateral lower side portion 330A extends linearly parallel to the first end surface 11C. Note that the second end of the first lateral lower side portion 330A is connected to an end of the second lower side portion 303A facing the first end surface 11C.

A first end of the second lateral lower side portion 330B illustrated in FIG. 6 is connected to an end of the upper side portion 301 facing the second end surface 11D. A second end of the second lateral lower side portion 330B is positioned at the same position as the end of the upper side portion 301 facing the second end surface 11D in the direction along the second axis Y, and is positioned on the third negative direction Z2 side relative to the first end described above. That is, the second lateral lower side portion 330B extends linearly parallel to the second end surface 11D. Note that the second end of the second lateral lower side portion 330B is connected to an end of the third lower side portion 303B facing the second end surface 11D.

The lower side portion 302 illustrated in FIG. 6 is positioned on the third negative direction Z2 side relative to the center of the element body 11 in the direction along the third axis Z, when viewed toward the first negative direction X2. That is, the lower side portion 302 is positioned on a side closer to the bottom surface 11E relative to the upper side portion 301.

The first lower side portion 302A illustrated in FIG. 6 has a first portion 312 extending linearly and a second portion 322 extending linearly. A first end of the first portion 312 is connected to an end of the second lower side portion 303A facing the bottom surface 11E. A second end of the first portion 312 is positioned on the second negative direction Y2 side and the third negative direction Z2 side relative to the first end. That is, the first portion 312 linearly and obliquely extends toward the bottom surface 11E and the second end surface 11D from the end of the second lower side portion 303A facing the bottom surface 11E to the point N3 closest to the bottom surface 11E in the winding portion 30A.

A first end of the second portion 322 illustrated in FIG. 6 is connected to the end of the first portion 312 facing the bottom surface 11E, that is, the second end of the first portion 312. A second end of the second portion 322 is connected to an end of the third lower side portion 303B facing the bottom surface 11E. That is, the second portion 322 linearly and obliquely extends from the end of the first portion 312 facing the bottom surface 11E toward the top surface 11F and the second end surface 11D.

With the configuration described above, the first lower side portion 302A is bent and extends to protrude toward the bottom surface 11E when viewed toward the first negative direction X2. The connection point between the first portion 312 and the second portion 322 on the edge of the first lower side portion 302A on the third negative direction Z2 side is the point N3 of the first lower side portion 302A closest to the bottom surface 11E. A vicinity of the point N3 in the first lower side portion 302A is positioned between the end of the second lower side portion 303A facing the bottom surface 11E and the bottom surface 11E, in the direction along the third axis Z. The point N3 is positioned on the second negative direction Y2 side relative to an end of the first electrode 40 on the second negative direction Y2 side. Further, the point N3 is positioned on the second positive direction Y1 side relative to an end of the second electrode 50 on the second positive direction Y1 side. That is, the point N3 is positioned between the first electrode 40 and the second electrode 50 along the second axis Y. Note that, in FIG. 6, a boundary between the first portion 312 and the second portion 322 is virtually indicated by a broken line. Further, a boundary between the first portion 312 and the second lower side portion 303A, and a boundary between the second portion 322 and the third lower side portion 303B each are virtually indicated by a broken line.

With the use of the inductor wiring 30 illustrated in the example of FIG. 6, the diameter of the winding portion 30A may be made larger in comparison with a configuration in which the first lower side portion 302A is parallel to the bottom surface 11E. Therefore, with the use of the configuration above, an increase in the inductance value of the inductor component 10 may be expected. Further, the point N3 of the first lower side portion 302A closest to the bottom surface 11E is positioned between the first electrode 40 and the second electrode 50 in the direction along the second axis Y. Therefore, the point N3 does not overlap with the first electrode 40 and the second electrode 50 in the direction along the second axis Y. That is, in the configuration described above, the diameter of the winding portion 30A is made larger with the first lower side portion 302A being unlikely to overlap with the first electrode 40 and the second electrode 50. As a result, the inductor component 10 may achieve an increase in the inductance value while suppressing a decrease in the Q factor.

The inductor wiring 30 is not limited to the embodiments described above and the example of FIG. 6, and may be wound in another way. For example, the inductor wiring 30 may have a so-called longitudinal winding in which a central axis of the winding is an axis along the second axis Y.

The configuration of the inductor wiring 30 in FIG. 6 may be combined with the configuration of the inductor wiring 30 of each of the first embodiment and the second embodiment. That is, when viewed toward the first negative direction X2, the configuration in which the first lower side portion 302A extends to protrude toward the bottom surface 11E and the configuration in which the first lateral side portion 304A extends to protrude toward the first end surface 11C may be combined. Furthermore, the configuration in which the second lateral side portion 304B extends to protrude toward the second end surface 11D may be combined.

In the first embodiment, the first lateral side portion 304A and the second lateral side portion 304B may extend linearly parallel to the first end surface 11C. In the case above, the entirety of a linearly extending lateral side portion is positioned closer to the center than is an end of the upper side portion 301.

In the first embodiment and the second embodiment, the point N1 of the first lateral side portion 304A closest to the first end surface 11C may be positioned closer to the bottom surface 11E than is the end of the first electrode 40 on the third positive direction Z1 side. In the respect above, the same applies to the relationship between the second electrode 50 and the point N2 of the second lateral side portion 304B closest to the second end surface 11D.

Technical thoughts that may be derived from the embodiments and modifications described above will be described below.

[1] An inductor component, comprising a rectangular parallelepiped element body having six outer surfaces; and inductor wiring extending inside the element body. The element body has a first electrode connected to a first end of the inductor wiring and a second electrode connected to a second end of the inductor wiring. When, among the six outer surfaces of the element body, one specific surface is defined as a main surface, one surface perpendicular to the main surface is defined as an end surface, and one surface perpendicular to the main surface and the end surface is defined as a bottom surface, the first electrode includes a bottom surface electrode portion exposed to an outside of the element body in a region of the bottom surface including a boundary portion with the end surface, and an end surface electrode portion exposed to the outside of the element body in a region of the end surface including a boundary portion with the bottom surface. Also, when a size of the bottom surface electrode portion in a direction perpendicular to the bottom surface is defined as a thickness of the bottom surface electrode portion, and a portion of the bottom surface electrode portion farthest from the end surface is defined as a leading end, the thickness of at least part of the bottom surface electrode portion including the leading end decreases toward the leading end.

[2] The inductor component according to [1], wherein the thickness of the bottom surface electrode portion continuously decreases toward the leading end with a constant gradient.

[3] The inductor component according to [1], wherein the thickness of the bottom surface electrode portion decreases stepwise toward the leading end.

[4] The inductor component according to any one of [1] to [3], wherein the bottom surface electrode portion includes a portion having a constant thickness.

[5] An inductor component, comprising: a rectangular parallelepiped element body having six outer surfaces; and inductor wiring extending inside the element body. The element body has a first electrode connected to a first end of the inductor wiring and a second electrode connected to a second end of the inductor wiring. When, among the six outer surfaces of the element body, one specific surface is defined as a main surface, one surface perpendicular to the main surface is defined as an end surface, and one surface perpendicular to the main surface and the end surface is defined as a bottom surface, the first electrode includes a bottom surface electrode portion exposed to an outside of the element body in a region of the bottom surface including a boundary portion with the end surface, and an end surface electrode portion exposed to the outside of the element body in a region of the end surface including a boundary portion with the bottom surface. Also, when a size of the end surface electrode portion in a direction perpendicular to the end surface is defined as a thickness of the end surface electrode portion, and a portion of the end surface electrode portion farthest from the bottom surface is defined as a leading end, the thickness of at least part of the end surface electrode portion including the leading end decreases toward the leading end.

[6] The inductor component according to [5], wherein the thickness of the end surface electrode portion continuously decreases toward the leading end with a constant gradient.

[7] The inductor component according to [5], wherein the thickness of the end surface electrode portion decreases stepwise toward the leading end.

[8] The inductor component according to any one of [5] to [7], wherein the end surface electrode portion includes a portion having a constant thickness.

[9] The inductor component according to any one of [1] to [8], wherein, when, among the six outer surfaces of the element body, a surface parallel to the end surface is defined as a second end surface, the second electrode includes a second bottom surface electrode portion exposed to the outside of the element body in a region of the bottom surface including a boundary portion with the second end surface, and a second end surface electrode portion exposed to the outside of the element body in a region of the second end surface including a boundary portion with the bottom surface.

[10] The inductor component according to any one of [1] to [9], wherein the inductor wiring includes an annular winding portion in which turns of the inductor wiring overlap with each other when viewed in a direction perpendicular to the main surface, and the winding portion includes a wiring main body extending with a constant line width and a protrusion portion protruding from an edge of the wiring main body.

[11] The inductor component according to any one of [1] to [10], wherein, when, among the six outer surfaces of the element body, a surface parallel to the bottom surface is defined as a top surface, the inductor wiring includes an annular winding portion in which turns of the inductor wiring overlap with each other when viewed in a direction perpendicular to the main surface, the winding portion includes an upper side portion closest to the top surface among portions parallel to the top surface, a lower side portion extending from a position closest to the bottom surface to the same position as an end of the upper side portion facing the end surface in a direction perpendicular to the end surface, and a lateral side portion connecting an end of the lower side portion facing the end surface and the end of the upper side portion facing the end surface, and at least part of the lateral side portion is positioned closer to the end surface than is the end of the upper side portion facing the end surface.

[12] The inductor component according to any one of [1] to [11], wherein, when, among the six outer surfaces of the element body, the end surface is defined as a first end surface, a surface parallel to the first end surface is defined as a second end surface, and a surface parallel to the bottom surface is defined as a top surface, the inductor wiring includes an annular winding portion in which turns of the inductor wiring overlap with each other when viewed in a direction perpendicular to the main surface, the winding portion includes an upper side portion closest to the top surface among portions parallel to the top surface and a lower side portion including a position closest to the bottom surface, and the lower side portion includes a first portion extending obliquely and linearly to the position closest to the bottom surface toward the bottom surface and the second end surface, and a second portion extending obliquely and linearly from an end of the first portion facing the bottom surface toward the top surface and the second end surface.

[13] The inductor component according to any one of [1] to [12], further comprising a covering electrode covering a surface, exposed to the outside of the element body, of one or more selected from the first electrode and the second electrode.

What is claimed is:

1. An inductor component, comprising:
a rectangular parallelepiped element body having six outer surfaces; and
inductor wiring extending inside the element body,
wherein
the element body has a first electrode connected to a first end of the inductor wiring and a second electrode connected to a second end of the inductor wiring,
when, among the six outer surfaces of the element body,
one specific surface is defined as a main surface,
one surface perpendicular to the main surface is defined as an end surface, and
one surface perpendicular to the main surface and the end surface is defined as a bottom surface,
the first electrode includes a bottom surface electrode portion exposed to an outside of the element body in a region of the bottom surface including a boundary portion with the end surface, and an end surface electrode portion exposed to the outside of the element body in a region of the end surface including a boundary portion with the bottom surface, and
when a size of the bottom surface electrode portion in a direction perpendicular to the bottom surface is defined as a thickness of the bottom surface electrode portion, and a portion of the bottom surface electrode portion farthest from the end surface is defined as a leading end,
the thickness of at least part of the bottom surface electrode portion including the leading end decreases toward the leading end.

2. The inductor component according to claim 1, wherein
the thickness of the bottom surface electrode portion continuously decreases toward the leading end with a constant gradient.

3. The inductor component according to claim 1, wherein
the thickness of the bottom surface electrode portion decreases stepwise toward the leading end.

4. The inductor component according to claim 1, wherein
the bottom surface electrode portion includes a portion having a constant thickness.

5. An inductor component, comprising:
a rectangular parallelepiped element body having six outer surfaces; and
inductor wiring extending inside the element body,
wherein
the element body has a first electrode connected to a first end of the inductor wiring and a second electrode connected to a second end of the inductor wiring,
when, among the six outer surfaces of the element body,
one specific surface is defined as a main surface,
one surface perpendicular to the main surface is defined as an end surface, and
one surface perpendicular to the main surface and the end surface is defined as a bottom surface,
the first electrode includes a bottom surface electrode portion exposed to an outside of the element body in a region of the bottom surface including a boundary portion with the end surface, and an end surface electrode portion exposed to the outside of the element body in a region of the end surface including a boundary portion with the bottom surface, and
when a size of the end surface electrode portion in a direction perpendicular to the end surface is defined as a thickness of the end surface electrode portion, and a portion of the end surface electrode portion farthest from the bottom surface is defined as a leading end,
the thickness of at least part of the end surface electrode portion including the leading end decreases toward the leading end.

6. The inductor component according to claim 5, wherein
the thickness of the end surface electrode portion continuously decreases toward the leading end with a constant gradient.

7. The inductor component according to claim 5, wherein
the thickness of the end surface electrode portion decreases stepwise toward the leading end.

8. The inductor component according to claim 5, wherein
the end surface electrode portion includes a portion having a constant thickness.

9. The inductor component according to claim 1, wherein
when, among the six outer surfaces of the element body, a surface parallel to the end surface is defined as a second end surface,
the second electrode includes a second bottom surface electrode portion exposed to the outside of the element body in a region of the bottom surface including a boundary portion with the second end surface, and a second end surface electrode portion exposed to the outside of the element body in a region of the second end surface including a boundary portion with the bottom surface.

10. The inductor component according to claim 1, wherein
the inductor wiring includes an annular winding portion in which turns of the inductor wiring overlap with each other when viewed in a direction perpendicular to the main surface, and
the winding portion includes a wiring main body extending with a constant line width and a protrusion portion protruding from an edge of the wiring main body.

11. The inductor component according to claim 1, wherein
when, among the six outer surfaces of the element body, a surface parallel to the bottom surface is defined as a top surface,
the inductor wiring includes an annular winding portion in which turns of the inductor wiring overlap with each other when viewed in a direction perpendicular to the main surface,
the winding portion includes
an upper side portion closest to the top surface among portions parallel to the top surface,
a lower side portion extending from a position closest to the bottom surface to the same position as an end of the upper side portion facing the end surface in a direction perpendicular to the end surface, and
a lateral side portion connecting an end of the lower side portion facing the end surface and the end of the upper side portion facing the end surface, and
at least part of the lateral side portion is positioned closer to the end surface than is the end of the upper side portion facing the end surface.

12. The inductor component according to claim 1, wherein
when, among the six outer surfaces of the element body,
the end surface is defined as a first end surface,
a surface parallel to the first end surface is defined as a second end surface, and
a surface parallel to the bottom surface is defined as a top surface,
the inductor wiring includes an annular winding portion in which turns of the inductor wiring overlap with each other when viewed in a direction perpendicular to the main surface,
the winding portion includes
an upper side portion closest to the top surface among portions parallel to the top surface and
a lower side portion including a position closest to the bottom surface, and
the lower side portion includes a first portion extending obliquely and linearly to the position closest to the bottom surface toward the bottom surface and the second end surface, and a second portion extending obliquely and linearly from an end of the first portion facing the bottom surface toward the top surface and the second end surface.

13. The inductor component according to claim 1, further comprising:
a covering electrode covering a surface, exposed to the outside of the element body, of one or more selected from the first electrode and the second electrode.

14. The inductor component according to claim 5, wherein
when, among the six outer surfaces of the element body, a surface parallel to the end surface is defined as a second end surface,
the second electrode includes a second bottom surface electrode portion exposed to the outside of the element body in a region of the bottom surface including a boundary portion with the second end surface, and a second end surface electrode portion exposed to the outside of the element body in a region of the second end surface including a boundary portion with the bottom surface.

15. The inductor component according to claim 5, wherein
the inductor wiring includes an annular winding portion in which turns of the inductor wiring overlap with each other when viewed in a direction perpendicular to the main surface, and
the winding portion includes a wiring main body extending with a constant line width and a protrusion portion protruding from an edge of the wiring main body.

16. The inductor component according to claim 5, wherein
when, among the six outer surfaces of the element body, a surface parallel to the bottom surface is defined as a top surface,
the inductor wiring includes an annular winding portion in which turns of the inductor wiring overlap with each other when viewed in a direction perpendicular to the main surface,
the winding portion includes
an upper side portion closest to the top surface among portions parallel to the top surface,
a lower side portion extending from a position closest to the bottom surface to the same position as an end of the upper side portion facing the end surface in a direction perpendicular to the end surface, and
a lateral side portion connecting an end of the lower side portion facing the end surface and the end of the upper side portion facing the end surface, and
at least part of the lateral side portion is positioned closer to the end surface than is the end of the upper side portion facing the end surface.

17. The inductor component according to claim 5, wherein
when, among the six outer surfaces of the element body,
the end surface is defined as a first end surface,
a surface parallel to the first end surface is defined as a second end surface, and
a surface parallel to the bottom surface is defined as a top surface,
the inductor wiring includes an annular winding portion in which turns of the inductor wiring overlap with each other when viewed in a direction perpendicular to the main surface,
the winding portion includes
an upper side portion closest to the top surface among portions parallel to the top surface and
a lower side portion including a position closest to the bottom surface, and
the lower side portion includes a first portion extending obliquely and linearly to the position closest to the bottom surface toward the bottom surface and the second end surface, and a second portion extending obliquely and linearly from an end of the first portion facing the bottom surface toward the top surface and the second end surface.

18. The inductor component according to claim 5, further comprising:
a covering electrode covering a surface, exposed to the outside of the element body, of one or more selected from the first electrode and the second electrode.
